(19) United States
(12) Patent Application Publication
(10) Pub. No.: US 2023/0264222 A1
(43) Pub. Date: Aug. 24, 2023

(54) LIQUID MATERIAL DISCHARGE DEVICE AND LIQUID MATERIAL APPLICATION DEVICE

(71) Applicant: MUSASHI ENGINEERING, INC., Mitaka-shi, Tokyo (JP)

(72) Inventor: Kazumasa Ikushima, Mitaka-shi, Tokyo (JP)

(73) Assignee: MUSASHI ENGINEERING, INC., Mitaka-shi, Tokyo (JP)

(21) Appl. No.: 18/012,139

(22) PCT Filed: Jun. 16, 2021
(86) PCT No.: PCT/JP2021/022908

§ 371 Date: Dec. 21, 2022

(30) Foreign Application Priority Data
Jun. 23, 2020 (JP) 2020-107695

(51) Int. Cl. B05C 5/02; B05C 13/00

(52) U.S. Cl. CPC B05C 5/0225; B05C 13/00

(57) ABSTRACT

To provide a liquid material discharge device capable of adjusting relative alignment of a valve element with respect to a valve seat by mechanical means. A liquid material discharge device includes: a base member; a valve device mounted on the base member and including a valve element and a valve seat; and a valve driving device configured to move the valve element forward to and backward from the valve seat. The liquid material discharge device further includes an adjustment device 140 configured to adjust relative alignment of the valve element with respect to the valve seat, wherein the adjustment device includes a movable member 141 on which the valve driving device is disposed, and an inclination adjuster 146 configured to adjust an inclination of the movable member. A liquid material application device includes the liquid material discharge device.

### TECHNICAL FIELD

The present invention relates to a liquid material discharge device that discharges a liquid material from a nozzle by moving a valve element mounted on a valve stem forward to and backward from a valve seat and includes a device for adjusting relative alignment of the valve element with respect to the valve seat.

### BACKGROUND ART

There are known discharge devices that discharge a liquid material in a droplet from a nozzle communicating with a hole provided in a valve seat by moving a valve element mounted on a valve stem forward to and backward from the valve seat. In the discharge devices of this type, the valve element mounted on the valve stem is moved forward and backward by an actuator such as a pneumatic actuator or a piezoelectric element, and a tiny droplet is thereby discharged and flied.

As one of ways to adjust a discharge amount in the above discharge device, a movement amount of the valve element (hereinafter, sometimes referred to as a “stroke”) is adjusted by adjusting relative alignment of the valve element with respect to the valve seat.

For example, in Patent Document 1, a valve seat and a nozzle are retained in a retainer cup which is screwed into a thread of a second portion. The alignment of the valve seat relative to a valve element is adjusted by changing how far the retainer cup is screwed into the second portion (Paragraph [0054], FIG. 3A).

In Patent Document 2, as a valve closure structure is moved, there is generated data of voltage applied to a piezoelectric actuator and data of position, and a reference point is established on the basis of the voltage data and the position data. A stroke is adjusted by adjusting the voltage applied to the piezoelectric actuator using the reference point.

### PRIOR ART LIST

### Patent Document

Patent Document 1: Japanese Patent Laid-Open Publication No. 2013-46906

Patent Document 2: Japanese National Publication of International Patent Application No. 2018-526210

### SUMMARY OF THE INVENTION

### Problems to be Solved by the Invention

In the discharge device that discharges a liquid material by moving the valve element forward to and backward from the valve seat, continuous operation sometimes disrupt the relative alignment of the valve element with respect to the valve seat. Thus, adjustment is required to be performed on the relative alignment at regular intervals. Particularly, when a piezoelectric element is used as the actuator that moves the valve element mounted on the valve stem forward and backward as in Patent Document 1, the piezoelectric element is driven at high frequencies, causing a problem that minute vibrations transmitted through a housing of the discharge device loosen the screw and disturb the alignment of the valve seat.

As in Patent Document 2, the relative alignment of the valve element with respect to the valve seat can also be adjusted by electrical means instead of mechanical means. However, after the adjustment, the valve element starts to operate from a position shifted by an adjustment distance from an end point of the stroke. Thus, there is an issue that a distance usable for the operation is shortened and a range available for the stroke is narrowed.

An object of the present invention is to provide a liquid material discharge device capable of adjusting the relative alignment of the valve element with respect to the valve seat by mechanical means.

### Means for Solving the Problems

A liquid material discharge device according to the present invention includes: a base member; a valve device mounted on the base member and including a valve element and a valve seat; and a valve driving device configured to move the valve element forward to and backward from the valve seat. The liquid material discharge device further includes an adjustment device configured to adjust relative alignment of the valve element with respect to the valve seat, wherein the adjustment device includes a movable member on which the valve driving device is disposed, and an inclination adjuster configured to adjust an inclination of the movable member.

In the liquid material discharge device, the adjustment device may include an elastic portion that couples the movable member to the base member, and the inclination adjuster may mechanically fix the movable member that is set with a desired inclination.

In the liquid material discharge device, the inclination adjuster may include a protruded portion formed on the movable member, a contact member that is in contact with the protruded portion, and a fixed angle adjustment mechanism that fixes the contact member to the protruded portion, wherein the fixed angle adjustment mechanism may be able to adjust an angle at which the contact member is in contact with the protruded portion.

In the liquid material discharge device, the fixed angle adjustment mechanism may include a receiving member disposed in the protruded portion and a pulling member provided in the contact member and coupled to the receiving member.

In the liquid material discharge device, the receiving member may be rotatably disposed in the protruded portion and may include a thread groove into which the pulling member is screwed.

In the liquid material discharge device, the contact member may be provided with a fitting hole having a stepped portion, and the pulling member may include a large-diameter portion that is in contact with the stepped portion.

In the liquid material discharge device, the protruded portion may have a surface that is in contact with the contact member, the surface being rounded, and the protruded portion and the contact member may be in line contact with each other.

In the liquid material discharge device, the contact member may have a surface that is in contact with the protruded portion, the surface being obliquely disposed.

In the liquid material discharge device, the valve driving device may be disposed between the elastic portion and the adjuster.

In the liquid material discharge device, the valve driving device may be disposed on an opposite side from the inclination adjuster across the elastic portion.

In the liquid material discharge device, the valve driving device may be disposed on an opposite side from the elastic portion across the inclination adjuster.

In the liquid material discharge device, the inclination adjuster and the elastic portion may be provided on a bottom-face side of the movable member.

In the liquid material discharge device, the inclination adjuster and the elastic portion may be provided on a top-face side of the movable member.

In the liquid material discharge device, the inclination adjuster and the elastic portion may be provided on a farthest-face side of the movable member from the valve driving device, and the valve driving device may be provided on a top-face side or a bottom-face side of the movable member.

In the liquid material discharge device, the base member, the movable member, and the elastic portion may be integrally formed.

In the liquid material discharge device, the valve device may include: a valve stem provided with the valve element; a liquid chamber in which the valve element moves forward and backward; a liquid inlet that communicates with the liquid chamber and through which a liquid material is supplied; a nozzle that communicates with the liquid chamber and has a discharge port through which the liquid material is ejected; the valve seat having a through-hole communicating with the discharge port of the nozzle; and a biasing member that biases the valve stem, wherein the valve driving device may include an arm that is coupled to the actuator and is in separable contact with the valve stem.

In the liquid material discharge device, the valve driving device may include an actuator that moves the valve element forward and backward.

A liquid material application device according to the present invention includes: the above-described liquid material discharge device; a worktable on which an application target is placed; a relative driving device configured to move the liquid material discharge device and the worktable relative to each other; and a control device configured to control operation of each of the devices.

### Advantageous Effect of the Invention

According to the present invention, it is possible to provide a liquid material discharge device capable of adjusting the relative alignment of the valve element with respect to the valve seat by mechanical means.

### BRIEF DESCRIPTION OF THE DRAWINGS

FIG. 1 is a partial cross-sectional view of a discharge device according to an embodiment.

FIG. 2 is an enlarged partial cross-sectional view illustrating details of an adjustment device of the discharge device of the embodiment.

FIG. 3 is an enlarged partial cross-sectional view illustrating an operation of the adjustment device of the discharge device of the embodiment. (A) shows a state where a valve element is shifted closer to a valve seat compared to a state of FIG. 2, and (B) shows a state where the valve element is shifted away from the valve seat compared to the state of FIG. 2.

FIG. 4 (A) is a partial cross-sectional view illustrating a first variation in which a movable member is extended toward an opposite side from an inclination adjuster across an elastic portion, and (B) is a partial cross-sectional view illustrating a second variation in which the movable member is extended toward an opposite side from the elastic portion across the inclination adjuster.

FIG. 5 is a partial cross-sectional view illustrating a third variation relevant to an arrangement of the adjustment device.

FIG. 6 is a partial cross-sectional view illustrating a fourth variation relevant to the arrangement of the adjustment device.

FIG. 7 (A) is a partial cross-sectional view illustrating a fifth variation in which the inclination adjuster is in contact with a protruded portion of the movable member from a rear side, and (B) is a partial cross-sectional view illustrating a sixth variation in which the inclination adjuster is in contact with the protruded portion of the movable member from a front side.

FIG. 8 (A) is a partial cross-sectional view illustrating a seventh variation in which a valve driving device is installed on a top-side face of the movable member, and (B) is a partial cross-sectional view illustrating an eighth variation in which the valve driving device is installed on a bottom-side face of the movable member.

FIG. 9 is a partial cross-sectional view illustrating a ninth variation in which the elastic portion is provided parallel to the movable member.

FIG. 10 (A) is a partial cross-sectional view illustrating a tenth variation in which the elastic portion is integrally formed with a base member, and (B) is a partial cross-sectional view illustrating an eleventh variation in which the elastic portion is integrally formed with the base member.

FIG. 11 is a perspective view of an application device including the discharge device according to the embodiment.

### MODE FOR CARRYING OUT THE INVENTION

Embodiments of the present invention will be described below.

Hereinafter, in some cases, for convenience of explanation, a nozzle side is referred to as “down”, an arm side is referred to as “up”, a valve-device side is referred to as “front”, and a valve-driving-device side is referred to as “rear”.

### Discharge Device

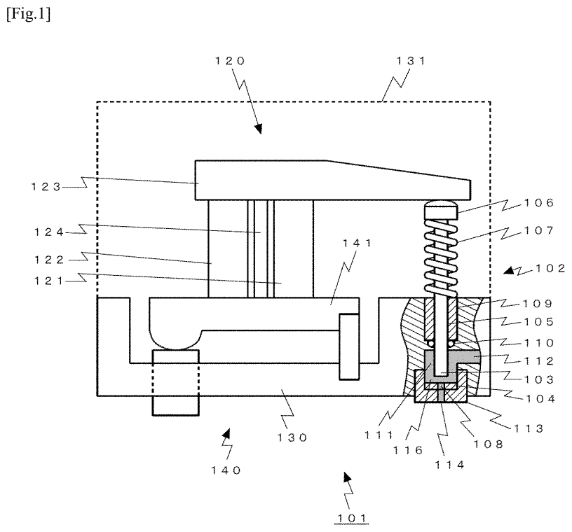

As shown in FIG. 1, a discharge device 101 according to an embodiment includes, as main components, a valve device 102, a valve driving device 120, an adjustment device 140, and a base member 130 on which they are mounted. The discharge device 101 relates to a jet-type discharge device that discharges and flies a liquid material 116 in the form of a droplet.

The valve device 102 is mounted on a front side of the base member 130 and mainly includes a valve element 103 and a valve seat 104. The valve element 103 is a lower end portion of a valve stem 105 and is located in a liquid chamber 111 provided in a lower front of the base member 130. In the example, the valve element 103 has a cylindrical shape with a flat tip, but is not limited to this shape. For example, the tip may be spherical, depressed, or tapered, or may be provided with a projection at a position facing a discharge port 114. The valve stem 105 is inserted through a bush 109 and a seal member 110 disposed in an insertion hole 108 and through a biasing member 107, which are provided above the liquid chamber 111.

Meanwhile, the valve stem 105 includes, at an upper end thereof, a contact portion 106 having a larger diameter than the valve stem 105, and is in separable contact with an arm 123 of the valve driving device 120. A bottom surface of the contact portion 106, which is coupled with the valve stem 105, is biased by an upper end of the biasing member 107 so that the contact portion 106 is in contact with the arm 123 with a variable contact position. A lower end of the biasing member 107 is in contact with a top surface of the base member 130. A top surface of the contact portion 106, which is in contact with the arm 123, is curved to be able to allow contact position and angle to vary depending on pivoting of the arm 123 described below. In FIG. 1, the biasing member 107 is a helical compression spring, but another biasing member 107 such as a disc spring may be used.

The liquid chamber 111 has a lower end to which a nozzle 113 having the discharge port 114 communicating with the liquid chamber 111 is attached. The liquid chamber 111 has a bottom surface constituted by the valve seat 104 that is attached to an inner bottom surface of the nozzle 113. The valve seat 104 is provided with a through-hole 115 communicating with the discharge port 114 of the nozzle 113. In FIG. 1, the valve seat 104 and the nozzle 113 are constituted by separate members but may be integrated by forming the inner bottom surface of the nozzle 113 as the valve seat 104. The liquid chamber 111 includes, on a lateral side thereof, a liquid inlet 112 through which the liquid material 116 is supplied. The liquid inlet 112 is connected to a liquid material supply source such as a reservoir not shown.

The valve driving device 120 includes actuators (121, 122), the arm 123, and a fixture 124. The two actuators (121, 122) are arranged in a front-rear direction on a movable member 141 of the adjustment device 140, and have respective lower ends coupled to a swinging mechanism not shown and respective upper ends fixed to the arm 123. The actuators (121, 122) are constituted by piezoelectric elements with the same specifications each configured to elongate and contract in a stacking direction (vertical direction in FIG. 1) by applying a voltage. The arm 123 is a bar-shaped member extending from the actuators (121, 122) toward the valve device 102 and is fixed by the fixture 124 disposed between the two actuators (121, 122) such that the arm 123 holds the actuators (121, 122) between the arm 123 and the movable member 141 of the adjustment device 140. The arm 123 has a front bottom surface in contact with the contact portion 106 provided at the upper end of the valve stem 105. The arm 123 transmits displacements of the actuators (121, 122) to the valve stem 105, and moves the valve element 103 forward to and backward from the valve seat 104. A configuration and an adjustment operation of the adjustment device 140 will be described below.

The discharge device 101 of this embodiment is covered by a cover 131 represented by the dotted line in terms of operator protection and device protection.

### Discharge Operation

The discharge device 101 of the embodiment shown in FIG. 1 performs a discharge operation as follows.

Assume that a neutral position of the valve element 103 is a position at the time when a front-side first actuator 121 and a rear-side second actuator 122 are not displaced.

When the front-side first actuator 121 is displaced to elongate, and the rear-side second actuator 122 is displaced to contract or is not displaced, the arm 123 pivots upward (counterclockwise in FIG. 1) around the fixture 124, resulting in the front of the arm 123 going up. When the front of the arm 123 goes up, the valve stem 105 goes up due to an action of the biasing member 107, and the valve element 103 moves away from the valve seat 104 (in this embodiment, this direction is referred to as a backward direction). A position of the valve element 103 farthest away from the valve seat 104 is regarded as an uppermost position.

When the front-side first actuator 121 is displaced to contract or is not displaced, and the rear-side second actuator 122 is displaced to elongate, the arm 123 pivots downward (clockwise in FIG. 1) around the fixture 124, resulting in the front of the arm 123 going down. When the front of the arm 123 goes down, the valve stem 105 is pushed by the arm 123 to go down, and the valve element 103 moves closer to the valve seat 104 (in this embodiment, this direction is referred to as a forward direction). A position of the valve element 103 closest to the valve seat 104 is regarded as a downmost position. Note that the downmost position may be such a position that the valve element 103 is not in contact with the valve seat 104.

The stroke is a movement distance from the uppermost position to the neutral position, from the neutral position to the downmost position, or from the uppermost position to the downmost position.

Combination of the above motions allows for moving the valve element 103 forward and backward in the liquid chamber 111. Then, inertial force is applied to the liquid material 116 present below the valve element 103 by the downward motion (forward motion), so that the liquid material 116 can be discharged in a droplet form from the discharge port 114 of the nozzle 113. Furthermore, the liquid material 116 can be successively discharged in a droplet form by iterating the forward and backward movement of the valve element 103 in the liquid chamber 111.

Adjusting displacement amounts of the two actuators (121, 122) allows for adjusting the stroke amount of the valve element 103. Adjusting the stroke amount of the valve element 103 allows for adjusting an amount of the liquid material 116 to be discharged from the discharge port 114 of the nozzle 113. This adjustment corresponds to the above stroke adjustment by electrical means using actuators.

### Adjustment Device

A configuration of the adjustment device 140 of the discharge device 101 according to the embodiment will be described.

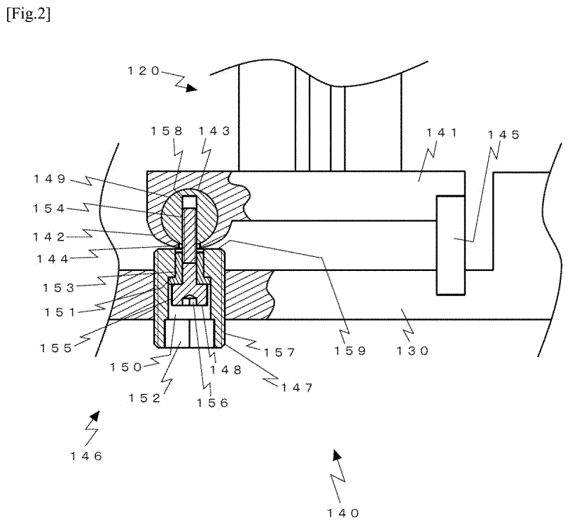

As shown in FIG. 2, the adjustment device 140 includes the movable member 141, an elastic portion 145, and an inclination adjuster 146.

The movable member 141 is constituted by a block-like or plate-like member disposed with a gap from the base member 130 and has a protruded portion 142 on a side (bottom surface) facing the base member 130. The valve driving device 120 is installed on an upper side of the movable member 141. In FIG. 2, the valve driving device 120 is arranged between the elastic portion 145 and the protruded portion 142 (or the inclination adjuster 146 described below) in the front-rear direction. The protruded portion 142 preferably has a curved shape (rounded surface) of which apex is in contact with an end surface 159 of a contact member 147 described below to be able to respond to a shift in an adjustment operation described later. The protruded portion 142 more preferably has a smooth periphery that is in contact with the end surface 159 on a line. For example, the protruded portion 142 may be formed into a semicircular columnar shape or a semi-elliptical columnar shape such that an outer periphery thereof is in line contact with the end surface 159.

The elastic portion 145 fixes the base member 130 to the movable member 141 and is constituted by a plate-like member (for example, plate spring) bendable in the front-rear direction in FIG. 2. The elastic portion 145 of the embodiment is detachable but may be integrally formed as in a tenth variation described below. Note that, though the elastic portion 145 is provided at an end of the movable member 141 nearer the valve element 103 in FIG. 2, the elastic portion 145 may naturally be provided in the vicinity of the end.

The inclination adjuster 146 includes the contact member 147, a pulling member 148, and a receiving member 149, and adjusts an inclination of the movable member 141 in the front-rear direction. The contact member 147 is a cylindrical bolt with a thread 157 on an outer surface. The contact member 147 is screwed into a through-hole provided in the base member 130 at a position facing the protruded portion 142 of the movable member. The contact member 147 is screwed into the through-hole of the base member 130 to project from a top surface of the base member 130 and be in contact with the protruded portion 142. A protruded amount of the contact member 147 from the top surface of the base member 130 can be adjusted by the thread 157 and a thread groove formed in the through-hole of the base member 130. The end surface 159 of the contact member 147 to be in contact with the protruded portion 142 is flat and is substantially in line contact with the curved protruded portion 142. The contact member 147 is provided with a fitting hole 150 extending through the center thereof, and the pulling member 148 can be fitted into the fitting hole 150. As shown in FIG. 2, in the embodiment, a bush 153 with a flange is provided between the pulling member 148 and the fitting hole 150 for smooth straight and rotational motion of the pulling member 148. The fitting hole 150 has a stepped portion 151 at a midpoint of an inner surface thereof, and the flange of the bush 153 is in contact with the stepped portion 151. Note that, in a configuration without the bush 153, a surface of a large-diameter portion 155 of the pulling member 148 continuous with a small-diameter portion 154 is in contact with the stepped portion 151.

In addition, the fitting hole 150 has, on a side (lower side) not in contact with the protruded portion 142, an end opening formed into a receiving hole 152 for a tool that rotates the contact member 147. The receiving hole 152 has, for example, a hexagonal or rectangular shape to allow a general tool such as a polygonal wrench to be used. The pulling member 148 is a bolt including the small-diameter portion 154 with a thread on a part or all of an outer periphery, and the large-diameter portion 155 connected to the small-diameter portion 154. The large-diameter portion 155 has, on a side not connected to the small-diameter portion 154, an end surface provided with a receiving recessed portion 156 for receiving a tool that rotates the pulling member 148. The receiving recessed portion 156 is, for example, a hexagonal hole or a plus- or minus-shaped groove to allow a tool such as a screwdriver to be used. The small-diameter portion 154 of the pulling member 148 is screwed into a female thread 158 of the receiving member 149.

A curved portion of the protruded portion 142 that is in contact with the contact member 147 (that is, the apex) is provided with a through-hole 144 through which the pulling member 148 is inserted. This through-hole 144 is of a size to be able to accommodate relative motion between the pulling member 148 and the movable member 141 in the adjustment operation described below. The receiving member 149 is a cylindrical nut provided with the female thread 158 extending from an outer periphery via the center toward the opposite-side surface. The female thread 158 does not penetrate through the receiving member 149 in FIG. 2, but it may penetrate through the receiving member 149. The receiving member 149 is slidably housed in a cylindrical space 143 provided in the protruded portion 142 and can rotate in a circumferential direction.

### Adjustment Operation

The adjustment device 140 of the embodiment shown in FIG. 2 operates as follows to adjust relative alignment between the valve element 103 and the valve seat 104.

### (A) Valve Element Downward Adjustment Operation

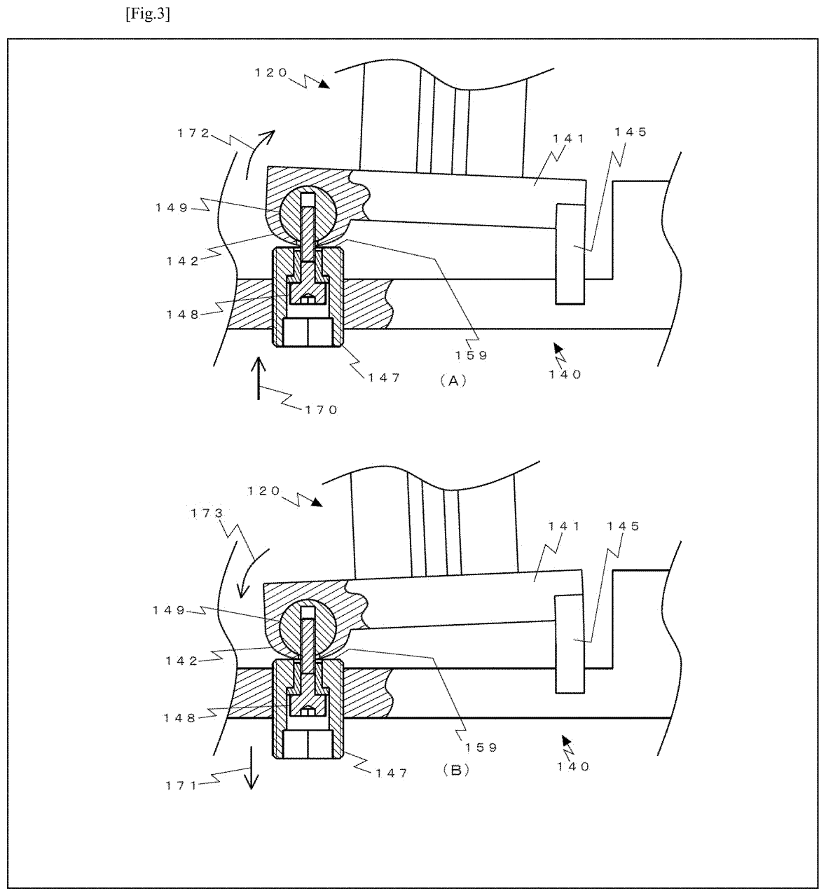

A downward adjustment operation of the valve element 103 will be described. First, in the neutral state, the pulling member 148 is rotated with a tool or the like to go down and separates from the stepped portion 151 of the contact member 147. Next, the contact member 147 is rotated with a tool or the like to go up, causing the end surface 159 of the contact member to push up the protruded portion 142 of the movable member 141 (reference symbol 170). Since the end of the movable member 141 on a side opposite to the protruded portion 142 is fixed with the elastic portion 145, the movable member 141 pivots upward (clockwise in FIG. 3) around an approximate center of the elastic portion 145 (reference symbol 172). Since the receiving member 149 is rotatably housed in the cylindrical space 143, the pivoting of the movable member 141 does not hamper the upward and downward motions of the contact member 147 and the pulling member 148. When the movable member 141 pivots to incline with a front side down, the valve driving device 120 installed thereon also moves to incline toward the front. Then, the arm 123 of the valve driving device 120 moves to push down the valve stem 105 of the valve device 102, and the valve element 103 at the lower end of the valve stem 105 shifts closer to the valve seat 104. After completion of the shift by a desired distance, the pulling member 148 is rotated with the tool to go up until it comes in contact with the stepped portion of the contact member 147. In this way, the contact member 147 is fixed to the protruded portion 142 and is restricted in movement so that the movable member 141 and alignment of the valve element 103 linked thereto are fixed (see FIG. 3(A)). That is, the pulling member 148 serves to fix the movable member 141 and eventually fix the alignment of the valve element 103.

Thus, adjusting the inclination of the movable member 141 and an angle at which the contact member 147 is in contact with the protruded portion 142 allows for adjusting the relative alignment between the valve element 103 and the valve seat 104. Note that the valve element downward adjustment operation may begin with the step of rotating the contact member 147 with the tool to go up without the first step of downward motion of the pulling member 148.

### (B) Valve Element Upward Adjustment Operation

An upward adjustment operation of the valve element 103 will be described. First, in the neutral state, the pulling member 148 is rotated with the tool to go down. Next, the contact member 147 is rotated with the tool to go down until the stepped portion 151 of the contact member 147 comes in contact with the large-diameter portion 155 of the pulling member 148 (reference symbol 171), and the end surface 159 of the contact member separates from the protruded portion 142. Then, the pulling member 148 is rotated with the tool to go up, causing the receiving member 149 to go down instead of the pulling member 148 going up. This action of the receiving member 149 going down lowers the protruded portion 142 of the movable member 141 toward the end surface 159 of the contact member. Since the end of the movable member 141 on the side opposite to the protruded portion 142 is fixed with the elastic portion 145, the movable member 141 pivots downward (counterclockwise in FIG. 3) around an approximate center of the elastic portion 145 (reference symbol 173). Since the receiving member 149 is rotatably housed in the cylindrical space 143, the pivoting of the movable member 141 does not hamper the upward and downward motions of the contact member 147 and the pulling member 148. When the movable member 141 pivots to incline with a rear side down, the valve driving device 120 installed thereon also moves to incline toward the rear. Then, a tip of the arm 123 of the valve driving device 120 goes up, and the valve stem 105 of the valve device 102 is accordingly lifted up by the action of the biasing member 107. As a result, the valve element 103 at the lower end of the valve stem 105 shifts away from the valve seat 104. The pulling member 148 is further rotated, and when the protruded portion 142 comes in contact with the end surface 159 of the contact member, the movable member 141 stops to incline and the alignment of the valve element 103 is fixed (see FIG. 3(B)).

Thus, adjusting the inclination of the movable member 141 and the angle at which the contact member 147 is in contact with the protruded portion 142 allows for adjusting the relative alignment between the valve element 103 and the valve seat 104. Note that the valve element upward adjustment operation may begin with the step of rotating the contact member 147 with the tool to go down without the first step of downward motion of the pulling member 148.

The relative alignment of the valve element 103 with respect to the valve seat 104 can be adjusted by repeating appropriately-selected one of the above two operations (upward adjustment and downward adjustment). That is, the stroke amount can be adjusted without any electrical means using the actuators. The effect of converting the linear motion by the two members (147, 148) into the curved motion of the movable member 141 is realized by the protruded portion 142 having a curved shape and by the receiving member 149 having a cylindrical shape to be freely rotatable.

According to the adjustment device and the method of the embodiment described above, the alignment of the valve element 103 and the valve seat 104 can be mechanically set without needing adjustment by electrical means using the actuators (121, 122). In addition, the movable member 141 on which the valve driving device 120 is installed is fixed to the base member 130 at the two points of the elastic portion 145 and the inclination adjuster 146, resulting in a more rigid structure. This can mitigate the problem that vibrations due to the operation of the actuators (121, 122) cause a change in the set alignment of the valve element 103 and the valve seat 104.

### Variations of Arrangement of Valve Driving Device

In the above embodiment, the valve driving device 120 is installed on the movable member 141 at a position between the elastic portion 145 and the inclination adjuster 146 (or the protruded portion 142) in the front-rear direction (in the side view of the discharge device 101). However, the present invention is not limited thereto, and the valve driving device 120 may be installed at another position.

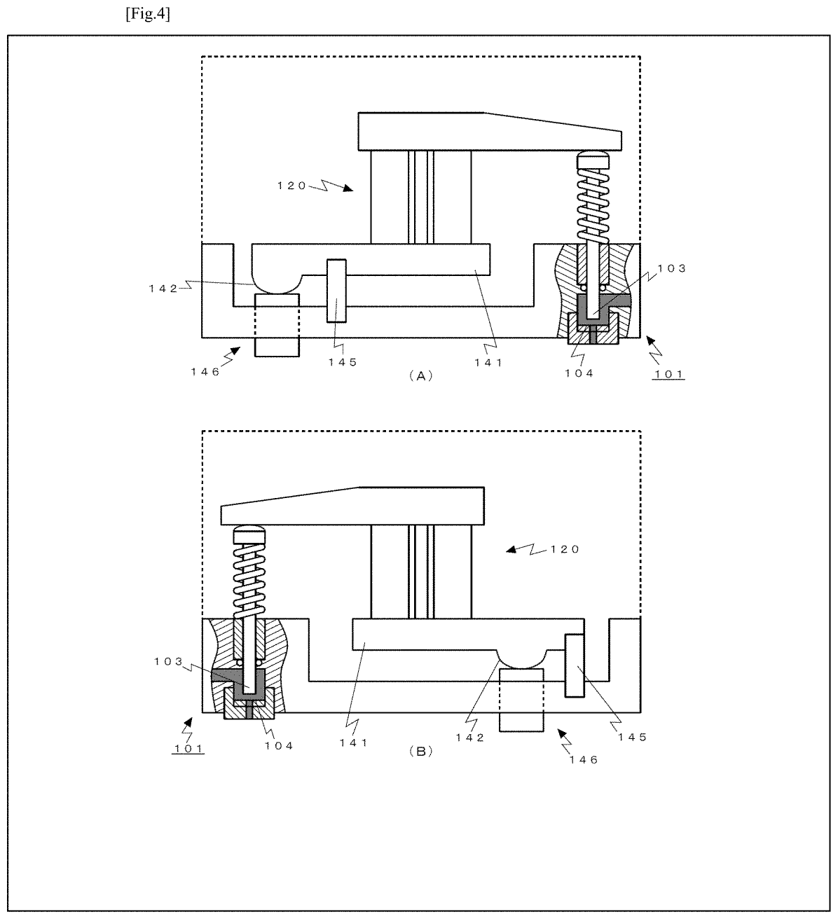

For example, in a first variation shown in FIG. 4(A), the movable member 141 is extended toward an opposite side from the inclination adjuster 146 across the elastic portion 145 in the front-rear direction (in the side view of the discharge device 101), and the valve driving device 120 is installed on the extended portion. In other words, the elastic portion 145 is provided between the valve driving device 120 and the protruded portion 142 in the front-rear direction (in the side view of the discharge device 101).

Furthermore, in a second variation shown in FIG. 4(B), the movable member 141 is extended toward an opposite side from the elastic portion 145 across the inclination adjuster 146 in the front-rear direction (in the side view of the discharge device 101), and the valve driving device 120 is installed on the extended portion. In other words, the elastic portion 145 is provided at an end (here, may be provided in the vicinity of the end) of the movable member 141 farther from the valve driving device 120 in the front-rear direction (in the side view of the discharge device 101).

In either case, a longer distance from the inclination adjuster 146 to the valve driving device 120 than in the case of FIG. 2 can enlarge the pivoting motion (that is, inclination degree) of the movable member 141 and enlarge an adjustment range of the alignment of the valve element 103 relative to the valve seat 104.

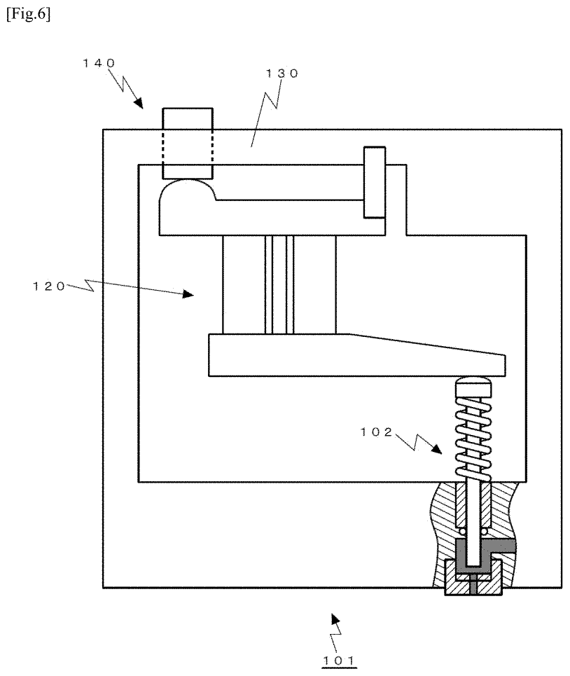

Note that, though the valve driving device 120 is installed on a face (top face) opposite to the protruded portion 142 in the variations of FIG. 4, the valve driving device 120 may be installed on the same face (bottom face) as the protruded portion 142. In this case, an orientation of the arm 123 may be changed as in a fourth variation of FIG. 6 described below.

### Variations of Arrangement of Adjustment Device

In the above embodiments, the adjustment device 140 is provided on a lower side of the discharge device 101. However, the present invention is not limited thereto, and the adjustment device 140 may be provided at another position.

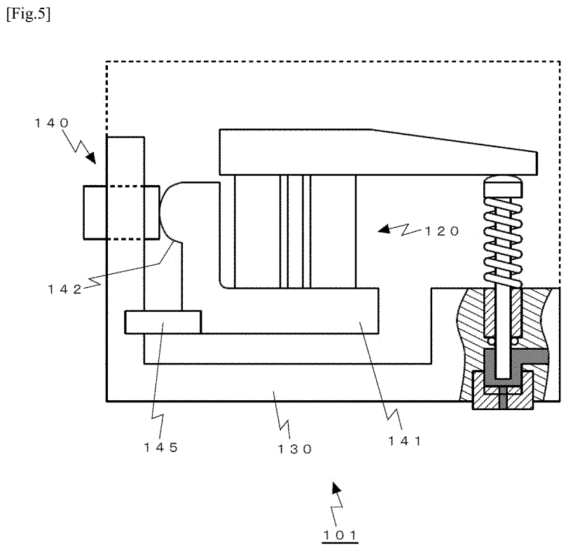

For example, in a third variation shown in FIG. 5, the base member 130 is formed into a shape extending in the vertical direction on a rear side (that is, substantially into an L shape), and the adjustment device 140 is provided on the rear side of the discharge device 101. That is, the movable member 141 is formed into an L shape, and the protruded portion 142 is provided on a tip of the extended portion. The movable member 141 is also fixed by the elastic portion 145 from the rear.

In a fourth variation shown in FIG. 6, the base member 130 is formed into a frame shape in the side view, and the adjustment device 140 is provided on an upper side of the discharge device 101. Depending on the positional relationship between the adjustment device 140 and the valve device 102, the valve driving device 120 is provided upside down.

In a case where it is difficult to access the adjustment device 140 from a lower side due to installation requirements of the discharge device 101 or the like, providing the adjustment device 140 on the rear side as in FIG. 5 or providing the adjustment device 140 on the upper side as in FIG. 6 permits easy access to the adjustment device 140 for maintenance or the like.

Note that, in the variations of FIGS. 5 and 6, it is also possible to adopt the arrangement where the valve driving device 120 is provided on the opposite side from the inclination adjuster 146 across the elastic portion 145 as in FIG. 4(A) or where the valve driving device 120 is provided on the opposite side from the elastic portion 145 across the inclination adjuster 146 as in FIG. 4(B).

### Variations of Inclination Adjuster

In the above examples, in the neutral position, the inclination adjuster 146 is in contact at a substantially right angle to the extending direction of the movable member 141. However, the present invention is not limited thereto, and the inclination adjuster 146 may be in contact at another angle.

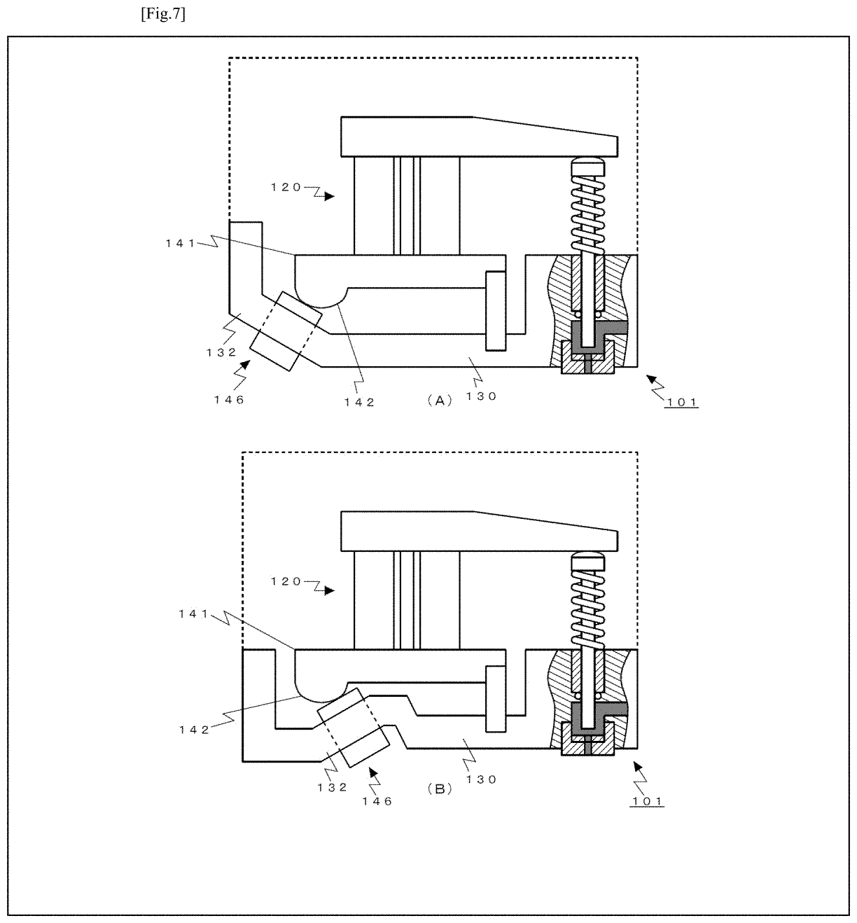

FIG. 7(A) shows a fifth variation in which the inclination adjuster 146 is in contact with the protruded portion 142 of the movable member 141 from a rear side. FIG. 7(B) shows a sixth variation in which the inclination adjuster 146 is in contact with the protruded portion 142 of the movable member 141 from a front side. In the fifth and sixth variations, the base member 130 is deformed such that the end surface 159 of the contact member facing the protruded portion 142 is oblique with respect to a vertical axis, and has a slope 132 into which the contact member 147 is screwed. Even though the end surface 159 of the contact member 147 constituting the inclination adjuster 146 is in contact with the protruded portion 142 obliquely as in the figure, the curved shape (columnar shape) of the protruded portion 142 allows for performing the adjustment operation.

Disposing the inclination adjuster 146 obliquely with respect to the extending direction of the movable member 141 (that is, on an upslope or downslope toward the front) as in FIG. 7 reduces the pivoting amount of the movable member 141 with respect to the movement amount of the inclination adjuster 146 as compared with the above examples, allowing for finer adjustment.

Note that, in the examples of FIG. 7, it is also possible to adopt the arrangement where the valve driving device 120 is provided on the opposite side from the inclination adjuster 146 across the elastic portion 145 as in FIG. 4(A) or where the valve driving device 120 is provided on the opposite side from the elastic portion 145 across the inclination adjuster 146 as in FIG. 4(B). Furthermore, in the examples of FIG. 7, it is also possible to adopt the arrangement where the adjustment device 140 is provided on the rear side of the discharge device 101 as in FIG. 5 or where the adjustment device 140 is provided on the upper side of the discharge device 101 as in FIG. 6.

### Variations of Arrangement of Valve Driving Device #2

In the above examples, the valve driving device 120 is installed on the face of the movable member 141 opposite to the face provided with the protruded portion 142. However, the present invention is not limited thereto, and the valve driving device 120 may be installed on a face of the movable member 141 perpendicular to the face provided with the protruded portion 142.

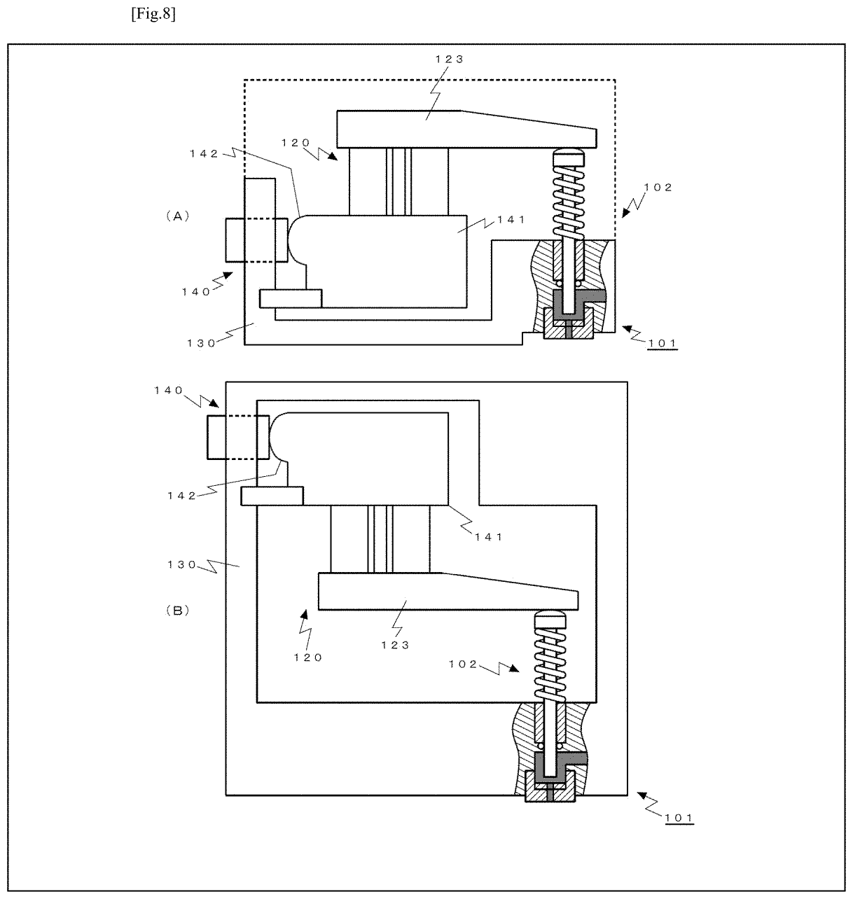

In a seventh variation shown in FIG. 8(A), like the third variation shown in FIG. 5, the base member 130 is formed into an L shape extending in the vertical direction on the rear side, and the adjustment device 140 is provided on the rear side of the discharge device 101. The movable member 141 is a block-like member that is long in the front-rear direction, and the valve driving device 120 is installed on a face (top face) perpendicular to the face (rear face) provided with the protruded portion 142.

In an eighth variation shown in FIG. 8(B), like the fourth variation shown in FIG. 6, the base member 130 is formed into a frame shape in the side view, and the adjustment device 140 is provided on a rear upper side of the discharge device 101. The movable member 141 is a block-like member that is long in the front-rear direction, and the valve driving device 120 is installed on a face (bottom face) perpendicular to the face (rear face) provided with the protruded portion 142. As in the variations shown in FIGS. 8(A) and 8(B), the valve driving device 120 may be provided on an upper side of the arm 123 or on a lower side of the arm 123.

Note that, in the examples of FIG. 8, it is also possible to adopt the configuration where the inclination adjuster 146 is disposed on a slope as in FIGS. 7(A) and 7(B).

### Variations of Elastic Portion

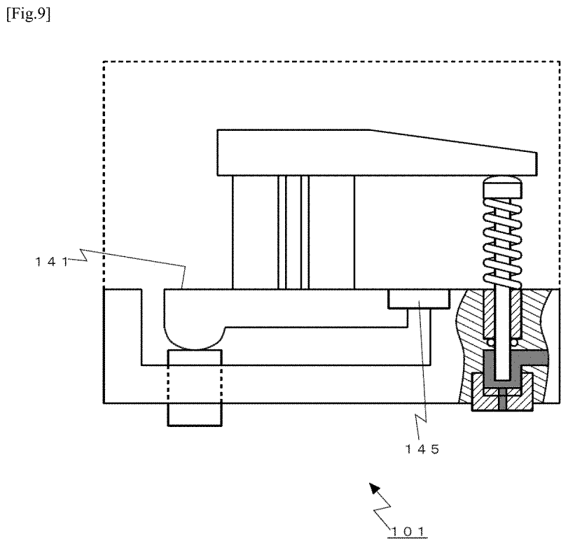

In the above examples, the elastic portion 145 is provided to extend perpendicularly to the extending direction of the movable member 141 (that is, extend in the vertical direction) and is bendable in the front-rear direction. However, the present invention is not limited thereto. For example, as in a ninth variation shown in FIG. 9, the elastic portion 145 may be provided to extend parallel to the extending direction of the movable member 141 (that is, in the front-rear direction or horizontally) and may be bendable in the vertical direction. Even though the elastic portion 145 is bendable in the vertical direction, the pivoting action of the movable member 141 is unaffected, yielding similar effects as in the above embodiment.

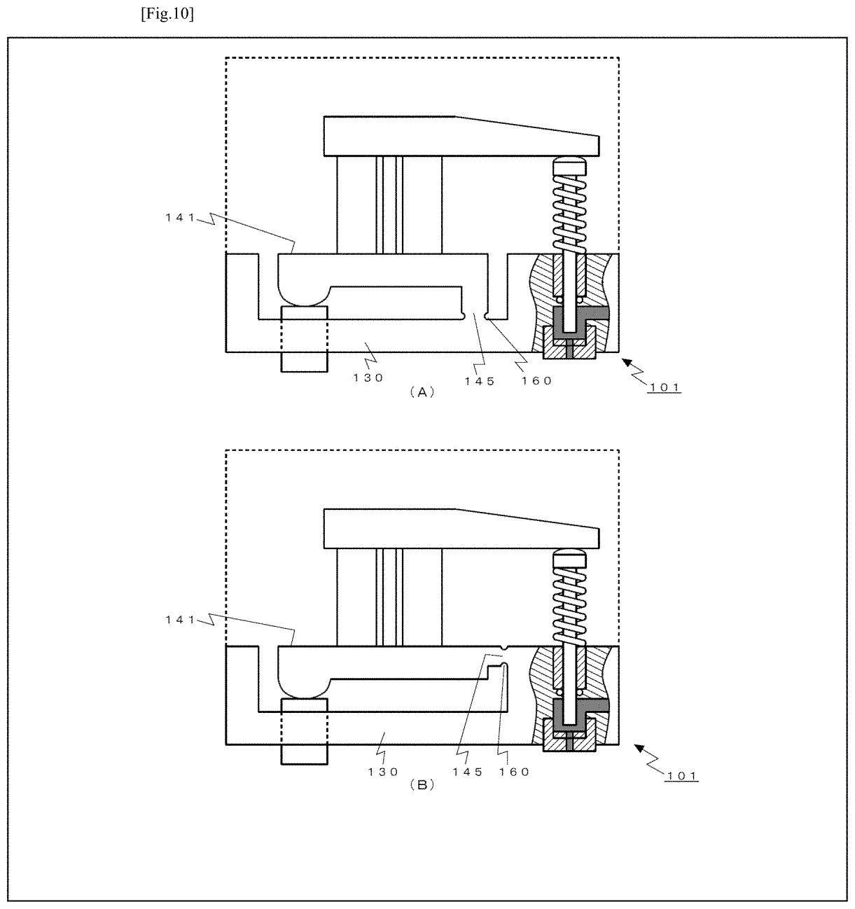

Moreover, the elastic portion 145 may be provided as a separate detachable 25 member as in the above embodiments or may be formed integrally with the base 130. For example, as in FIG. 10(A), the movable member 141 may have a front portion formed into an L shape in the side view, and the elastic portion 145 provided at a lower end of the front portion may be formed integrally with the base member 130. Alternatively, for example, as in FIG. 10(B), the elastic portion 145 disposed at the front portion of the movable member 141 extending to the front may be formed integrally with the base member 130. In these cases, a notch 160 may be provided for better bendability at a connecting portion between a portion of the movable member 141 as the elastic portion 145 and the base member 130, which can realize smooth pivoting of the movable member 141. Meanwhile, the integral formation of the members of the movable member 141 and the base member 130 results in a more rigid structure, which can suppress a change in the alignment due to vibrations of the actuators.

Note that, in the examples of FIGS. 9, 10(A), and 10(B), it is also possible to adopt the arrangement where the valve driving device 120 is provided on the opposite side from the inclination adjuster 146 across the elastic portion 145 as in FIG. 4(A) or where the valve driving device 120 is provided on the opposite side from the elastic portion 145 across the inclination adjuster 146 as in FIG. 4(B). Moreover, it is also possible to adopt the arrangement where the adjustment device 140 is provided on the rear side of the discharge device 101 as in FIG. 5 or where the adjustment device 140 is provided on the upper side of the discharge device 101 as in FIG. 6. Furthermore, it is also possible to adopt the configuration where the inclination adjuster 146 is disposed on a slope as in FIGS. 7(A) and 7(B). It is also possible to adopt the configuration where the valve driving device 120 and the protruded portion 142 are disposed on adjacent faces of the movable member 141 as in FIGS. 8(A) and 8(B).

### Application Device

The above discharge device 101 can be used by being mounted on an application device for discharging a liquid material to an application target.

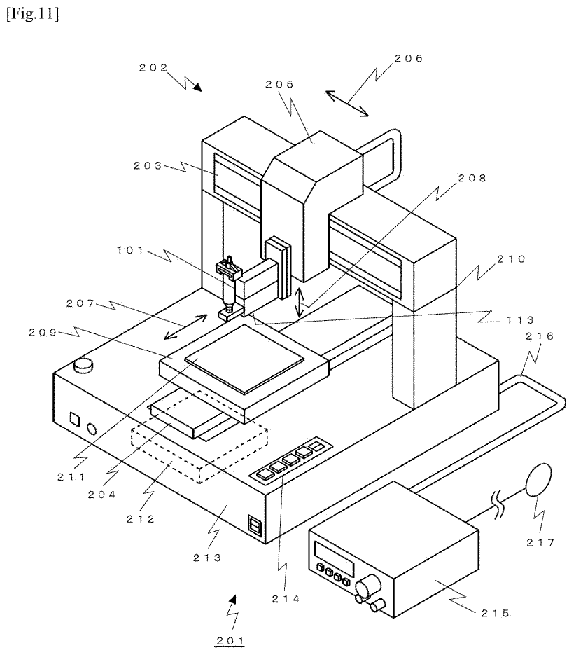

As shown in FIG. 11, an application device 201 of this embodiment mainly includes the discharge device 101 that discharges a liquid material 116, and an XYZ-driving device 202 as a relative driving device that moves the discharge device 101 and a worktable 209, on which an application target 211 is placed, relative to each other.

The XYZ-driving device 202 includes an X-driving device 203, a Y-driving device 204, and a Z-driving device 205 that move the discharge device 101 and the worktable 209 relative to each other in an X-direction 206, a Y-direction 207, and a Z-direction 208, respectively. In this embodiment, the Y-driving device 204 is provided on a top surface of a housing 213 to extend in the Y-direction 207, and the X-driving device 203 is provided on an arch-like frame 210 straddling the Y-driving driving device 204 in a direction perpendicular to the Y-driving device 204. The Z-driving device 205 is provided on the X-driving device 203, and the discharge device 101 is provided on the Z-driving device 205. In addition, the worktable 209 is installed on the Y-driving device 204, and is movable in the Y-direction 207. The discharge device 101 is installed on the Z-driving device 205, and is movable in the Z-direction 208 and the X-direction 206. This configuration allows the discharge device 101 and the application target 211 on the worktable 209 to move relative to each other in the X-direction 206, the Y-direction 207, and the Z-direction 208. The XYZ-driving device 202 can move a tip of the nozzle 113 of the discharge device 101 to an arbitrary position over the application target 211 at an arbitrary speed under control of a drive control device 212. Following devices can be used as the XYZ-driving device 202, for example: a combined device of an electric motor, such as a servomotor or a stepping motor, and a ball screw; a device using a linear motor; and a device using a belt or a chain to transmit power.

The worktable 209 is constituted by a plate-like member and has a mechanism (not shown) for fixing the application target 211. Following mechanisms can be used as the mechanism for fixing the application target, for example: a mechanism having a plurality of holes leading from an inside of the worktable 209 to its top surface and configured to suck and fix the application target 211 by sucking the air through the holes; and a mechanism that fixes the application target 211 by holding the application target 211 between fixing members and fixing those members to the worktable 209 with fixing means such as screws or the like.

Operation of the discharge device 101 including the nozzle 113 for discharging a liquid material is controlled by a discharge control device 215. The discharge control device 215 is connected to the XYZ-driving device 202 by a cable 216 and can control the discharge device 101 in conjunction with operation of the XYZ-driving device 202. The discharge control device 215 is connected to a compressed gas source 217 that supplies compressed gas for assisting the operation of the discharge device 101 and feeding the liquid material under pressure. It is also possible to adopt a configuration where the discharge control device 215 and the drive control device 212 are implemented as a physically single control device.

The application device 201 of this embodiment can be connected to an instruction terminal not shown. With the instruction terminal, it is possible to give instructions on positioning of the XYZ-driving device 202, an operation of the discharge device 101, and the like. The drive control device 212 stores the instructions. The application device 201 can sequentially set related instructions to execute them as a sequence of instructions. In other words, the application device 201 can operate the discharge device 101 and the XYZ-driving device 202 according to the instructions. This sequence of instructions is referred to as an application program. Following terminals can be used as the instruction terminal, for example: a dedicated terminal including a simple display device and a plurality of switches; and a personal computer with dedicated software installed. With the instruction terminal, it is possible to start and stop the operation of the application device 201 based on the application program stored in the drive control device 212. The start and stop operation can also be performed with a switch 214 installed on the top surface of the housing 213.

The preferred embodiments of the present invention have been described above. However, the technical scope of the present invention is not limited to the description of the above-described embodiments. Various alterations and modifications can be applied without departing from the technical idea of the present invention, and such altered or modified modes also fall within the technical scope of the present invention. For example, a bolt and a nut, which are thread elements, are used as the inclination adjuster 146 in the above description, but a rack and a pinion or a worm and a wheel, which are gear elements, may be used. Moreover, the thread elements or the gear elements may be connected to an electric motor or the like to allow for automatic control. Furthermore, the arm 123 may be altered in shape for such an arrangement that the elongating-contracting direction of the actuators (121, 122) and the movement direction of the valve element 103 is parallel to each other, perpendicular to each other, or at an angle other than parallel or perpendicular. Depending on the arrangement, it is possible to adopt an arrangement of the adjustment device 140 other than the above arrangements. That is, various arrangements can be adopted in view of a size of the discharge device 101, an installation environment of the discharge device 101, operability, and the like.

### List OF REFERENCE SYMBOLS

101: discharge device/102: valve device/103: valve element/104: valve seat/105: valve stem/106: contact portion/107: biasing member/108: insertion hole/109: bush (valve device)/110: seal member/111: liquid chamber/112: liquid inlet/113: nozzle/114: discharge port/115: through-hole (valve seat)/116: liquid material/120: valve driving device/121: first actuator (front)/122: second actuator (rear)/123: arm/124: fixture/130: base member/131: cover/132: slope/140: adjustment device/141: movable member/142: protruded portion/143: cylindrical space/144: through-hole (inclination adjuster)/145: elastic portion/146: inclination adjuster/147: contact member/148: pulling member/149: receiving member/150: fitting hole/151: stepped portion/152: receiving hole/153: bush (inclination adjuster)/154: small-diameter portion/155: large-diameter portion/156: receiving recessed portion/157: (male) thread/158: female thread/159: contact member end surface/160: notch/170: contact member up/171: contact member down/172: movable member upward (clockwise) pivoting/173: movable member downward (counterclockwise) pivoting/201: application device/202: XYZ-driving device/203: X-driving device/204: Y-driving device/205: Z-driving device/206: X-movement direction/207: Y-movement direction/208: Z-movement direction/209: worktable/210: frame/211: application target/212: drive control device/213: housing/214: switch/215: discharge control device/216: cable/217: compressed gas source

1. A liquid material discharge device comprising:
a base member;
a valve device mounted on the base member and including a valve element and a valve seat; and
a valve driving device configured to move the valve element forward to and backward from the valve seat;
wherein the liquid material discharge device further comprises an adjustment device configured to adjust relative alignment of the valve element with respect to the valve seat, and
wherein the adjustment device includes a movable member on which the valve driving device is disposed, and an inclination adjuster configured to adjust and mechanically fix an inclination of the movable member.

2. The liquid material discharge device according to claim 1, wherein the adjustment device includes an elastic portion that couples the movable member to the base member.

3. The liquid material discharge device according to claim 2, wherein the inclination adjuster includes a protruded portion formed on the movable member, a contact member that is in contact with the protruded portion, and a fixed angle adjustment mechanism that fixes the contact member to the protruded portion,
wherein the fixed angle adjustment mechanism is able to adjust an angle at which the contact member is in contact with the protruded portion.

4. The liquid material discharge device according to claim 3, wherein the fixed angle adjustment mechanism includes a receiving member disposed in the protruded portion and a pulling member inserted through the contact member and screwed into the receiving member.

5. The liquid material discharge device according to claim 4, wherein the receiving member is rotatably disposed in the protruded portion and includes a thread groove into which the pulling member is screwed.

6. The liquid material discharge device according to claim 4, wherein the contact member is provided with a fitting hole having a stepped portion, and
the pulling member includes a large-diameter portion that is in contact with the stepped portion.

7. The liquid material discharge device according to claim 4, wherein the protruded portion has a surface that is in contact with the contact member, the surface being rounded, and
the protruded portion and the contact member are in line contact with each other.

8. The liquid material discharge device according to claim 7, wherein the contact member has a surface that is in contact with the protruded portion, the surface being obliquely disposed.

9. The liquid material discharge device according to claim 2, wherein the valve driving device is disposed between the elastic portion and the adjuster.

10. The liquid material discharge device according to claim 2, wherein the valve driving device is disposed on an opposite side from the inclination adjuster across the elastic portion.

11. The liquid material discharge device according to claim 2, wherein the valve driving device is disposed on an opposite side from the elastic portion across the inclination adjuster.

12. The liquid material discharge device according to claim 9, wherein the inclination adjuster and the elastic portion are provided on a bottom-face side of the movable member.

13. The liquid material discharge device according to claim 9, wherein the inclination adjuster and the elastic portion are provided on a top-face side of the movable member.

14. The liquid material discharge device according to claim 9, wherein the inclination adjuster and the elastic portion are provided on a farthest-face side of the movable member from the valve driving device, and
the valve driving device is provided on a top-face side or a bottom-face side of the movable member.

15. The liquid material discharge device according to claim 2, wherein the base member, the movable member, and the elastic portion are integrally formed.

16. The liquid material discharge device according to claim 1, wherein the valve driving device includes an actuator that moves the valve element forward and backward.

17. The liquid material discharge device according to claim 16, wherein the valve device includes:
a valve stem provided with the valve element;
a liquid chamber in which the valve element moves forward and backward;
a liquid inlet that communicates with the liquid chamber and through which a liquid material is supplied;
a nozzle that communicates with the liquid chamber and has a discharge port through which the liquid material is ejected;
the valve seat having a through-hole communicating with the discharge port of the nozzle; and
a biasing member that biases the valve stem;
wherein the valve driving device includes
an arm that is coupled to the actuator and is in separable contact with the valve stem.

18. A liquid material application device comprising:
the liquid material discharge device according to claim 1;
a worktable on which an application target is placed;
a relative driving device configured to move the liquid material discharge device and the worktable relative to each other; and
a control device configured to control operation of each of the devices.
